(19) United States
(12) Patent Application Publication
(10) Pub. No.: US 2023/0147696 A1
(43) Pub. Date: May 11, 2023

(54) TANK FOR PRESSURIZED GAS

(71) Applicant: FAURECIA SYSTEMES D'ECHAPPEMENT, NANTERRE (FR)

(72) Inventor: Eunji WALGENTWITZ, COURMONT (FR)

(21) Appl. No.: 17/983,026

(22) Filed: Nov. 8, 2022

(30) Foreign Application Priority Data
Nov. 10, 2021 (FR) 21 11932

(51) Int. Cl. F17C 13/02

(52) U.S. Cl. CPC F17C 13/02; F17C 2221/012; F17C 2223/036; F17C 2250/0469; F17C 2201/035

(57) ABSTRACT

A tank for pressurized gas, such as hydrogen, comprises a structure made of composite material and a sensor for detecting and locating a deformation of the structure. The sensor comprises at least two first linear sensitive elements, which are sensitive to a non-localized elongation, and are rigidly attached the structure and laid out substantially parallel to each other. A deformation of the structure is localized in a section defined by at least one of the first linear sensitive elements.

### CROSS-REFERENCE TO RELATED APPLICATIONS

This application is a U.S. non-provisional application claiming the benefit of French Application No. 21 11932, filed on Nov. 10, 2021, which is incorporated herein by reference in its entirety.

### TECHNICAL FIELD

The disclosure relates to a tank for pressurized gas, such as hydrogen, equipped with a sensor for detecting and locating any deformation of the tank structure.

### BACKGROUND

For storing a gas under pressure, it is known how to produce a tank comprising a structure made of composite material. Such a structure is typically manufactured by filamentary winding of a strip of composite material. Such structure is, in a known manner, lined on the inside by an envelope or “liner” providing sealing.

When the structure is damaged, either by intrinsic delamination of the composite material or by an extrinsic cause such as an impact, the tank is damaged. Given the high pressures and the possible adverse issues involved, such a situation has to be detected as soon as possible, in order to ensure whether or not a tank can still be used.

It is known how to equip a tank with sensors which are apt to detect and locate a deformation of the structure. A known embodiment consists in distributing, over substantially the entire surface of the structure, point sensors, sensitive to deformation, such as strain gages. Given the resolution of the desired localization, it is recommended to equip the tank with at least one-hundred-point sensors. The above leads, by multiplying by the number of wires per sensor, to a connection density on the same order: several hundred wires.

An alternative to a plurality of point sensors has also been sought.

### SUMMARY

The disclosure proposes a matrix solution, allowing the size of the connectors to be significantly reduced.

To this end, the subject matter of the disclosure is to equip the structure with a matrix sensor.

The disclosure relates to a tank for pressurized gas, such as hydrogen, comprising a composite material structure and a sensor for detecting and locating a deformation of the structure, wherein the sensor comprises at least two first linear sensitive elements which are sensitive to a non-localized elongation, and are rigidly attached to the structure and laid out substantially parallel to each other, and a deformation of the structure being localized in a section defined by at least one of the first linear sensitive elements.

Particular features or embodiments, which can be used alone or in combination, are:
the tank further comprises at least two second linear sensitive elements, sensitive to non-localized elongation, rigidly attached to the structure and arranged substantially parallel to each other and crossed with the first linear sensitive elements, a deformation of the structure being localized at the intersection of a first linear sensitive element and a second linear sensitive element,
said at least two first linear sensitive elements and said at least two second linear sensitive elements are perpendicular,
the tank has a substantially cylindrical shape, and said at least two first linear sensitive elements are laid out axially and said at least two second linear sensitive elements are laid out circumferentially,
two first linear sensitive elements, and two successive second linear sensitive elements, respectively, are separated by a distance comprised between 1 and 30 cm, preferentially between 5 and 20 cm, more preferentially equal to 10 cm,
the linear sensitive elements are laid out on the outer surface, or preferentially on the inner surface of the structure,
the linear sensitive elements are laid out in the thickness of the structure,
a linear sensitive element is a linear element, such as a piezoelectric cable, an optical strain gage cable, a reflectometer cable, a shape memory sensor cable or a strain gage cable,
a linear sensitive element is apt to withstand an elongation of at least 2%, preferentially of at least 5%.

### BRIEF DESCRIPTION OF THE DRAWINGS

The disclosure will be better understood upon reading the following description, given only as an example and making reference to the enclosed drawings, wherein:

FIG. 1 shows a tank in a perspective view

FIG. 2 shows a tank in a section view perpendicular to the axis thereof

FIG. 3 shows a detail of FIG. 2.

### DETAILED DESCRIPTION

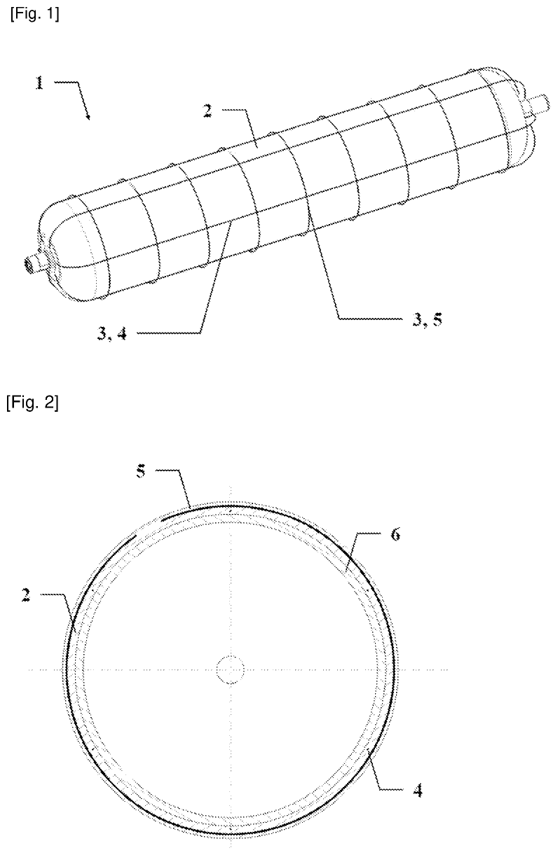

With reference to FIG. 1, the disclosure relates to a tank 1 for pressurized gas. Such a tank 1 is designed to store, more particularly, hydrogen for vehicle applications. Such a tank is subject to very high pressures, which can reach 1500 bars.

In order to meet such constraints, without requiring too great a mass, such a tank is, in a known manner, constructed around a structure 2 made of composite material.

In order to be able to detect and locate a possible deformation of the structure 2, the structure 2 is advantageously equipped with a sensor 3 for detecting and locating a deformation.

According to the proposition according to the disclosure, the sensor 3 comprises at least two first sensitive elements 4 and/or 5.

In opposition to a plurality of point sensitive elements which require an exorbitant number of connectors, the sensitive elements 4, 5 according to the disclosure are linear.

The sensitive elements 4, 5 comprise wires sensitive to a deformation in length or elongation. The detection principle is such that detection on a sensitive linear element 4, 5 does not need to be localized or situated along the element. Thereby, the sensitive elements 4, 5 considered are such that same supply an electrical signal indicative of a deformation or elongation of the sensitive element 4, 5, but without said elongation being necessarily localized longitudinally over the length of said sensitive element 4, 5.

A sensitive element 4, 5 can, however, be apt to localize a deformation along the length thereof, but such information on localization will not be used by the disclosure. Thereby, in order to be used in the disclosure, a sensitive element 4, 5, has to provide information on either the presence or the absence of deformation. Such information on the presence of a deformation can be on or off, or, where appropriate, quantified in terms of the size of the deformation.

A sensitive element 4, 5 is rigidly attached to the structure 2. Thus, a deformation of a sensitive element 4, 5 is indicative and representative of an equivalent deformation of the structure 2.

A first series comprises at least two such first sensitive elements 4. The sensitive elements 4 are laid out substantially parallel to one another. Every sensitive element 4 thus defines a section therearound. Thereby, with two sensitive elements 4, it is possible to detect a deformation in the vicinity of each of the two sensitive elements 4. A deformation detection can also be localized at one of the two neighborhoods. The number of sensitive elements 4 is thus a function of the desired spatial resolution. Such number is a compromise between high resolution and low cost.

According to another feature, making it possible to refine the spatial resolution of the detection of a deformation, the tank 1 further comprises at least two second sensitive elements 5. In this way, it is possible to go from a one-section localization to a localization in the vicinity of a crossing.

The selected spatial resolution can be different between the first series and the second series. However, the spatial resolution is advantageously substantially identical from one series to another.

A second series comprises at least two such second sensitive elements 5. The sensitive elements 5 are laid out substantially parallel to each other and crossed with the first sensitive elements 4 of the first series.

Said second series makes it possible to cross-reference the deformation information by using a matrix. Indeed, if a deformation occurs, the same will be detected by at least one first sensitive element 4 and by at least one second sensitive element 5. Also, said deformation can be localized at the crossing, at the intersection of the first sensitive element 4 detecting a deformation and of the second sensitive element 5 detecting a deformation.

Compared with connectors for N point detectors, which requires n.N wires, if n is the number of wires required for connecting a detector for obtaining a definition which provides N points or zones with the disclosure, only 2n.√N wires are required. Thereby for N=100 point detectors, 100.n wires are required, whereas the disclosure makes it possible to produce 100 points with 20.n wires. The number of connectors is divided by 5.

According to another feature, said at least two first sensitive elements 4 and said at least two second sensitive elements 5 are perpendicular to each other. The perpendicularity of linear sensitive elements 4, 5 is understood in the three-dimensional space. Thus, on a cylindrical or spherical support, a line can be a circle, perpendicular to a line or to another circle: equator and meridian.

According to another feature, the tank 1 has a substantially cylindrical shape. Such a tank 1 conventionally comprises a cylindrical central cross-section and two hemispherical end cups. In such case of use, as illustrated, said at least two first sensitive elements 4 are laid out axially, parallel to the axis of revolution of the cylinder, along the generatrices, and said at least two second sensitive elements 5 are laid out circumferentially, on circles centered on the axis of revolution.

The spacing between the sensitive elements 4, 5 gives the spatial resolution of the sensor 3. According to another feature, two successive first sensitive elements 4 are separated by a distance comprised between 1 and 30 cm, preferentially between 5 and 20 cm, further preferentially equal to 10 cm. Similarly, two successive second sensitive elements 5 have the same feature and are separated by a distance comprised between 1 and 30 cm, preferentially between 5 and 20 cm, further preferentially equal to 10 cm. The above determines the number of first sensitive elements 4 and of second sensitive elements 5. The sensitive elements 4, 5 of the same series are preferentially equally distributed.

It has been seen that the sensitive elements 4, 5 are rigidly attached to the composite structure 2 of the tank 1 so that an elongation of a sensitive element 4, 5 is representative of a deformation of the structure 2. Also, according to another feature, the sensitive elements 4, 5 are laid out on a surface of the structure 2. The same are rigidly attached to said surface in an intimate manner, typically by bonding. Said surface can be the outer surface. Said surface can also preferentially be the inner surface of the structure 2.

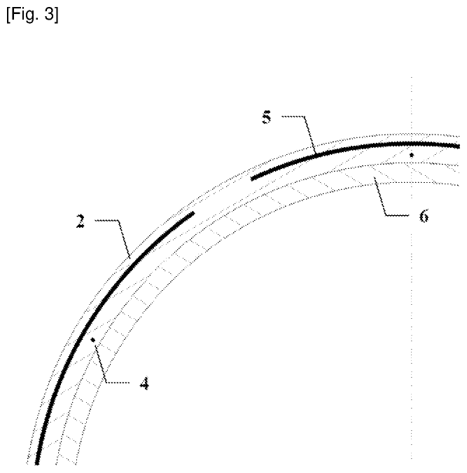

Alternatively, the sensitive elements 4, 5 are laid out within the thickness of the structure 2. The above is typically achieved by inserting the sensitive elements 4, 5 during the fabrication of the structure 2. Thereby, if the structure 2 is produced by filament winding, said winding is interrupted during the fabrication, the sensitive element(s) 4, 5 are inserted, and the winding is then resumed. Several interruptions are possible for inserting one or a plurality of sensitive elements 4, 5. The above is illustrated in FIGS. 2 and 3 where a series of first sensitive elements 4 is inserted substantially at a first third of the thickness of the structure 2, and a series of second sensitive elements 5 is inserted substantially at a second third of the thickness of the structure 2.

It is also possible to combine the two preceding features, certain sensitive elements 4, 5 being rigidly attached to each other, the other or both surfaces and other sensitive elements 4, 5 being embedded within the thickness of the structure 2.

A sensitive element 4, 5 is a linear element. Such a linear element can be produced according to different technologies. According to a first technology, a sensitive element 4, 5 is a piezoelectric cable. Such a cable is a cable incorporating piezoelectric components in such a way as to be able to detect a deformation of the cable and to supply an electrical signal indicative of such a deformation.

According to another technology, a sensitive element 4, 5 is an optical strain gage cable. Such a cable is a cable incorporating optical strain gages so as to be able to detect a deformation of the cable and to supply an electrical signal indicative of such a deformation.

According to another technology, a sensitive element 4, 5 is a reflectometer cable. Such a cable comprises an optical fiber equipped with a reflectometer. Such a reflectometer is apt to measure a modification of the optical fiber by emitting a light pulse and by measuring a signal reflected by the optical fiber, indicative of a deformation of the optical fiber.

According to another technology, a sensitive element 4, 5 is a shape memory sensor cable. Such an SMA cable (Shape Memory Alloy) incorporates sensors using shape memory alloys. Such detectors are apt to detect a deformation and to supply an electrical signal indicative of such a deformation. Such technology is advantageous in that unlike other technologies, same can withstand an elongation of up to 5%.

According to another technology, a sensitive element 4, 5 is a strain gage cable. Such a strain gage cable is also known as QRS (Quantum Resistive Strain). Such a cable incorporates strain gages. Such strain gages are apt to detect a deformation and to supply an electrical signal indicative of such a deformation.

According to another characteristic, a sensitive element is apt to withstand an elongation of at least 2%, preferentially of at least 5%.

The disclosure has been illustrated and described in detail in the drawings and the preceding description. Same should be considered as illustrative and given as an example and not as limiting the disclosure to said description alone. Many variants of embodiment are possible.

### LIST OF REFERENCE SIGNS

1: tank,

2: structure,

3: sensor,

4: first sensitive element,

5: second sensitive element,

6: envelope.

1. A tank for pressurized gas, such as hydrogen, comprising:
a structure made of composite material; and
a sensor to detect and locate a deformation of the structure, wherein the sensor comprises at least two first linear sensitive elements which are sensitive to a non-localized elongation, and are rigidly attached to the structure and laid out substantially parallel to each other, and a deformation of the structure being localized in a section defined by at least one first linear sensitive element.

2. The tank according to claim 1, wherein the sensor further comprises at least two second linear sensitive elements which are sensitive to a non-localized elongation, and are rigidly attached to the structure and laid out substantially parallel to each other and crossed with the at least two first linear sensitive elements, and a deformation of the structure being localized at a crossing between at least one first linear sensitive element and at least one second linear sensitive element.

3. The tank according to claim 2, wherein said at least two first linear sensitive elements and said at least two second linear sensitive elements are perpendicular.

4. The tank according to claim 2, wherein the tank has a substantially cylindrical shape, and wherein said at least two first linear sensitive elements are axially laid out and said at least two second linear sensitive elements are circumferentially laid out.

5. The tank according to claim 2, where two successive first linear sensitive elements and two second linear sensitive elements, respectively, are separated by a distance comprised between 1 and 30 cm.

6. The tank according to claim 2, where two successive first linear sensitive elements and two second linear sensitive elements, respectively, are separated by a distance comprised between 5 and 20 cm.

7. The tank according to claim 2, where two successive first linear sensitive elements and two second linear sensitive elements, respectively, are separated by a distance equal to 10 cm.

8. The tank according to claim 1, wherein the at least two first linear sensitive elements are laid out on an outer surface of the structure.

9. The tank according to claim 1, wherein the at least two first linear sensitive elements are laid out on an inner surface of the structure.

10. The tank according to claim 1, wherein the at least two first linear sensitive elements are laid out within a thickness of the structure.

11. The tank according to claim 1, wherein at least one of the first linear sensitive elements is a linear element, such as a piezoelectric cable, an optical strain gage cable, a reflectometer cable, a shape memory sensor cable or a strain gage cable.

12. The tank according to claim 1, wherein at least one of the first linear sensitive elements is apt to withstand an elongation of at least 2%.

13. The tank according to claim 1, wherein at least one of the first linear sensitive elements is apt to withstand an elongation of at least 5%.
